(19) United States
(12) Patent Application Publication
(10) Pub. No.: US 2009/0007033 A1
(43) Pub. Date: Jan. 1, 2009

(54) Method to transfer failure analysis-specific data between data between design houses and fab's/FA labs

(76) Inventor: Hitesh Suri, San Jose, CA (US)

Correspondence Address: DEBORAH W. WENOCUR, 4057 AMARANTA AVE., PALO ALTO, CA, 94306, US

(21) Appl. No.: 11/823,566

(22) Filed: Jun. 28, 2007

(51) Int. Cl. G06F 17/50

(52) U.S. Cl. 716/4

(57) ABSTRACT

A method and system for an IC design house to transfer design and layout information to a fabrication or failure analysis facility on a need-to-know basis to enable effective failure analysis while not providing unnecessary or extraneous information.

### FIELD OF THE INVENTION

This invention is in the field of integrated circuit failure analysis, and more particularly in the field of transfer of design data between design houses and fab's or FA labs for failure analysis.

### BACKGROUND OF THE INVENTION

In the current business environment for integrated circuit device manufacturing, an increasingly used business strategy is for the Integrated Device Manufacturers (IDM's) to go fab-lite or fab-less, and to separate the design and fabrication portions of the manufacturing by sending the fabrication portion of the jobs to dedicated fab companies such as TSMC, UMC, and Chartered.

Whereas the separation of design and fabrication tends to yield an increase in efficiency and lowering of costs, it raises some issues of concern to the manufacturers. The transfer of information between the design houses and the fabrication companies or the failure analysis labs can cause security concerns. This is particularly true when design houses need to transfer design-specific information to the fab or service houses for Failure Analysis (FA) work being done at the fab or service houses.

The basic information required by a fabrication facility in order to fabricate a design is the fabrication level GDS2 files, which show the actual layer-by-layer layout. The GDS2 files yield a local description of the layers, but do not include the descriptions of net names, cell names, or higher level connectivity. The GDS2 files are in binary format, and contain all the layout polygons and their corresponding layer information. Design level files, on the other hand, have different components, as follows:

Library Exchange Format (LEF) files contain building blocks of different Functional Units, e.g., NAND gates, in layout form, and depend on the design rules and the particular fab and technology (i.e., the LEF files are technology-specific). LEF files are normally provided by the fab for each chip. Design files created by the circuit designers are generally created in VHDL or Verilog formats—both ASCII files in high level logic-based languages. Electronic Design Automation (EDA) tools then synthesize, i.e., convert the design files to gate level Net lists in an Electronic Design Interchange Format (EDIF) file. From the EDIF file the EDA tools form Placement And Route (PAR) files which include the actual placement and routing of the Functional Units. From the PAR files, the EDA tools create the fabrication level GDS2 files, which show the actual layer-by-layer layout. The EDA tools can optionally create Design Exchange Format (DEF) files from the PAR files. The DEF files describe how the Functional Unit building blocks are placed and connected by nets, according to the circuit design and design rules. The DEF file is therefore a circuit design in layout format, and includes net connectivity and cell placement. Both the LEF file and the DEF file are in high level ASCII format.

A use of these design and fabrication files in Failure Analysis is described in commonly owned U.S. patent application Ser. No. 11/502,951, filed Aug. 11, 2006, and U.S. Pat. No. 5,675,499, issued Oct. 7, 1997, both of which are hereby incorporated by reference in their entireties. The LEF and DEF files are read by a SiGPS LEF/DEF Reader, then converted into a efficient, easily accessible binary format in a SiGPS database file. When queried, the database file can provide locations of polygons which satisfy specified conditions as to net, functional unit, and region. The SiGPS file can also be used in conjunction with GDS2 files. The GDS2 files have all the shapes that will be fabricated, in layout form. The user can identify these shapes from the GDS2 data. The SiGPS Database has the design element names, plus their corresponding polygons and location. The user can do a query into SiGPS database for a specific cell instance or net name, and the SiGPS database will return the corresponding polygons. As described in earlier incorporated U.S. patent application Ser. No. 11/502,951, a set of advanced algorithms known as OP3 utilize GDS2 files and the database file to determine optimal placements of probe points, net cuts, and net joins which are utilized in analysis and correction of failures. These determined placements can be indicated on the GDS2 files.

When the aforementioned strategy is used to have the fabrication and failure analysis performed in a special fab facility rather than by the design house, files and data must be transferred to the fab facility from the design facility. The GDS2 files provide the mask data, and are all that are required for the fabrication. However, for failure analysis additional information is generally required, including some net and/or connectivity data. Currently, the design houses send both the raw GDS2 files or mask data converted into a proprietary format, and additional design information, usually in ASCII format, such as the LEF/DEF, LVS, and/or schematic files. The schematic files are the actual circuit diagrams, which show the complete connectivity of the circuit design, rather than any placement data. The LVS (Layout Vs. Schematic) files check the GDS2 file to be sure it follows the schematic. The design house uses these files as inputs to a layout tool and failure analysis equipment. In this procedure, however, the transfer of the complete design files raises security concerns, and furthermore is not essential, since the FA engineers do not require the full mask data and design information for the FA job.

A method of providing to the fabrication facilities only the information required to perform effective Failure Analysis would alleviate these security concerns when using the fab-lite or fab-less IC manufacturing strategies for design houses.

### SUMMARY OF THE INVENTION

It is therefore an object of this invention to provide a method and system for an IC design house to transfer design and layout information to a fabrication or failure analysis facility on a need-to-know basis to enable effective failure analysis while not providing unnecessary or extraneous information.

This object is met by the methods described herein.

### BRIEF DESCRIPTION OF THE DRAWINGS

FIG. 1 is a chart indicating the steps of the present invention.

FIG. 2a shows an example of a unique feature at a first corner of a layout.

FIG. 2b shows an example of a unique feature at a second corner of a layout.

FIG. 2c shows an example of a unique feature at a third corner of a layout.

FIG. 2d shows an example of a unique feature at a fourth corner of a layout.

FIG. 3a shows an example of a portion of an IC, with highlighted regions indicating cells connected to a cell where a failure is detected or a design problem correction is anticipated.

FIG. 3b shows the result of an exemplary SiGPS query to identify the net and other connected cells to the originally identified cell of FIG. 3a.

FIG. 4 illustrates an enhanced GDS2 file which has the same bounding box 400 as the original mask data, and includes the unique features as well as the design specific information.

### DETAILED DESCRIPTION OF THE INVENTION

The present invention provides a method to transfer the necessary information (in addition to the standard GDS files) from the design house to the fab or facility which will be doing failure analysis on an IC, on a need-to-know basis so as to minimize security concerns. If the files are being transferred to a fab facility, the fab already has the GDS2 files, so they require the information additional to the GDS2. In case a Failure Analysis (FA) Service house is doing the analysis job, they don't need the standard GDS2 file, which is used for the fabrication. Only the necessary information, which may include some layout plus some design or connectivity information, can be extracted and sent over to them.

Failure analysis issues generally fall into three broad categories. The first is an actual failure of an operating circuit, often caused by a processing problem. A customer experiencing this type of failure will generally be able to indicate the location of the failure. The second type of failure analysis deals with design problems in a circuit. In this case, it is generally necessary to perform a circuit edit in a specific location, for example a net cut or a net join, in order to attempt to address the design problem. And a third type of issue is when a diagnostics failure shows up, during testing rather than during actual circuit operation. In this case, the diagnostics program will generally localized the failure to a specific cell or pin. This can then be correlated with the LEF/DEF/LVS/schematic files.

The present invention extracts and transfers design information targeted towards the Failure Analysis, including the three categories described above.

The actual planning and execution of Failure analysis may consist of three separate aspects:
1) Planning of a failure analysis strategy;
2) Probing a specified region or set of connected cells to determine the exact location of a failure; and
3) Determining the exact location(s) of, and performing, one or more circuit edit operations.
   In general, the design house maintains full control over strategy planning, and over the specification of locations for circuit edit once the exact failure location is determined. It also determines which cells or interconnect regions may need to be probed in order to exactly locate the fault. The fabrication facility may be responsible for doing the actual probing and providing the results to the design facility.

Probing of cells could mean probing the output pins of the cells, for example when using ATPG test results, as described hereinafter, or when using Time Resolved Emission (TRE) probing or Laser Voltage Probing (LVP). If the actual net (rather than output pins) is being probed, the design house may need to use the OP3 algorithms, described above, to specify the location on the net(s) where probe data needs to be acquired. However, if the probe data can be acquired at any location on the net, then the design house can leave the determination of the location to the FA/Fab house. Similarly, in the case of circuit edit, the design house may need to specify the cut or join edit locations on the net, or there may be circumstances when the fab/FA house can make the edit location determination.

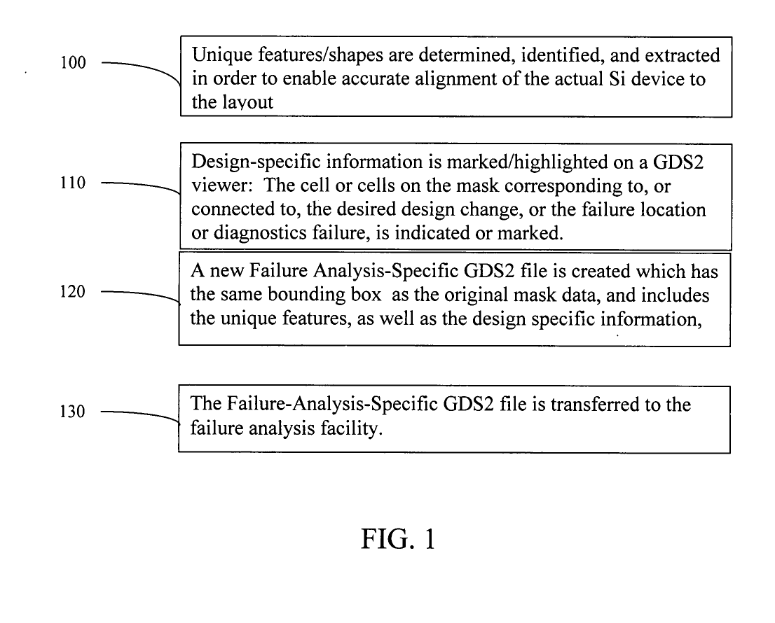

FIG. 1 is a chart indicating the steps of the present invention.

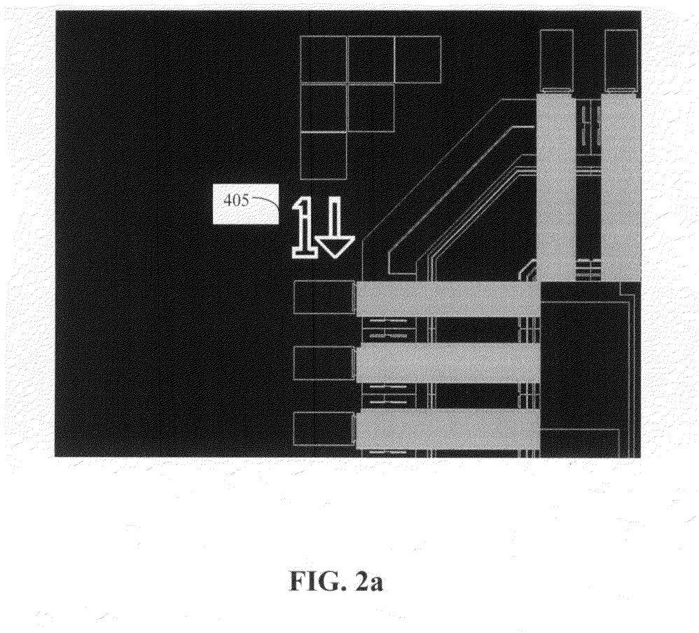

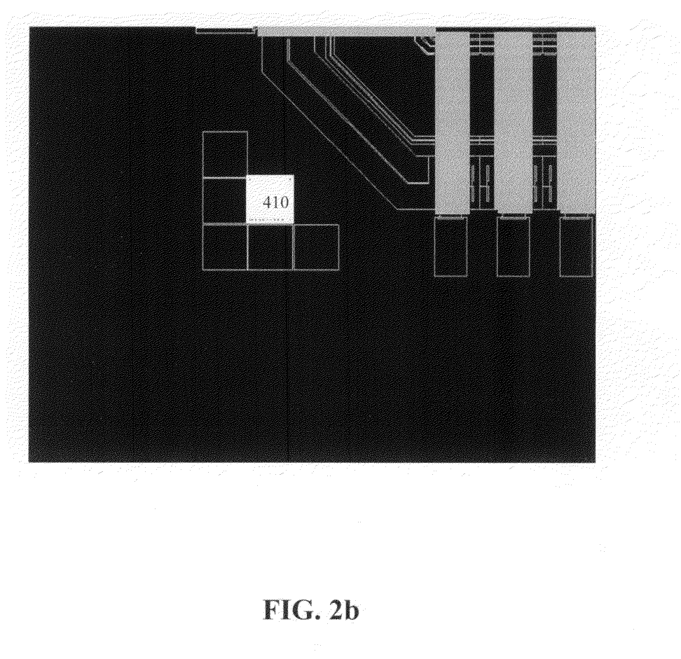

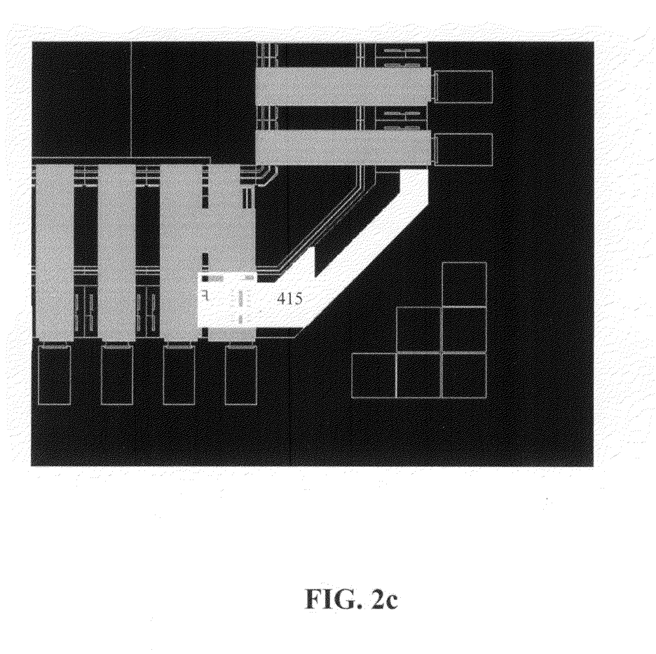

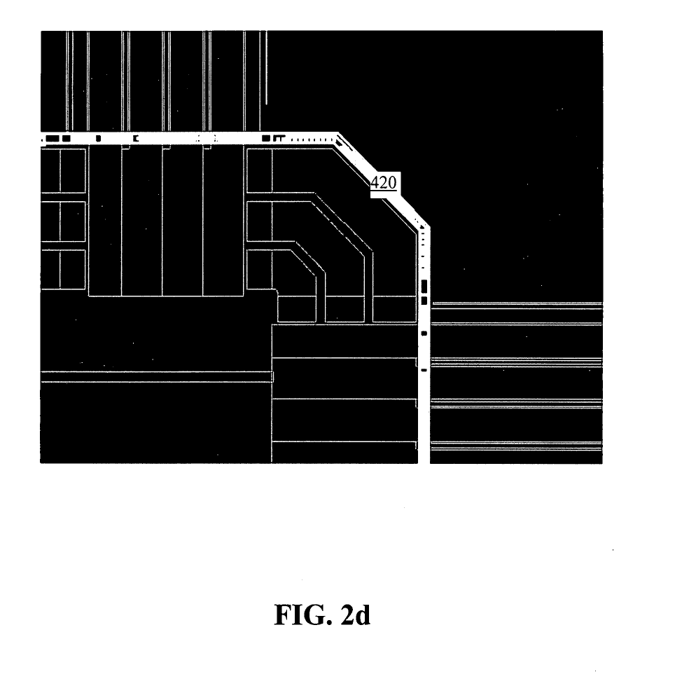

In step 100, unique features/shapes are determined, identified, and extracted (i.e., the GDS2 file is read and the polygons are identified by the user) in order to enable accurate alignment of the actual Si device to the layout. Unique features are simply easily identifiable (by shape) features that serve as identifiers in relation to the CAD layout. In general, a separate unique feature is chosen near each of the four corners of the device layout. FIGS. 2a-2d show examples of unique features at four corners of a layout. According to the present invention, those unique features are marked or highlighted on the original mask data. This may be accomplished by extracting the polygon shapes corresponding to the unique features from the GDS2 file or proprietary mask database. A separate abbreviated GDS2 file including only the necessary information is generally sent to the fabrication facility, although there may some situations where, if the fabrication facility has a full mask set, locations of the appropriate polygons on the mask data which they already have, may be all that is required to be sent.

In step 110, design-specific information is marked/highlighted on a GDS2 viewer which has the capability to superimpose LEF/DEF and LVS data on the GDS2 file. Then the cell or cells on the mask corresponding to, or connected to, the desired design change, or the failure location or diagnostics failure, all of which will be further discussed, is indicated or marked. The correspondence between location in the design and mask data or polygons is determined by querying the LEF/DEF database using SiGPS, or using LVS data or Physical Net Trace data. Physical Net Tracing is used when LEF/DEF or LVS Data is not available. It uses the rules file to see how different layers are connected. An example of a rule is that M1 connects to M2 thru VIA12. So when analyzing polygons on M1 and one comes across V12, it is deduced that M1 and V12 are connected. And when V12 polygons intersect with M2, a trace can be formed indicating that these M2 polygons are connected to the previously traced M1 polygons. The person preparing the data is generally the best judge as to which data to use, according in part to what data is available and what tools were used to identify the failures. By way of example, Automatic Test Pattern Generation (ATPG) tools such as TetraMax from Synopsys gives errors in the form of cell/pin names. In that case, SiGPS data would be the best for extracting the cell locations.

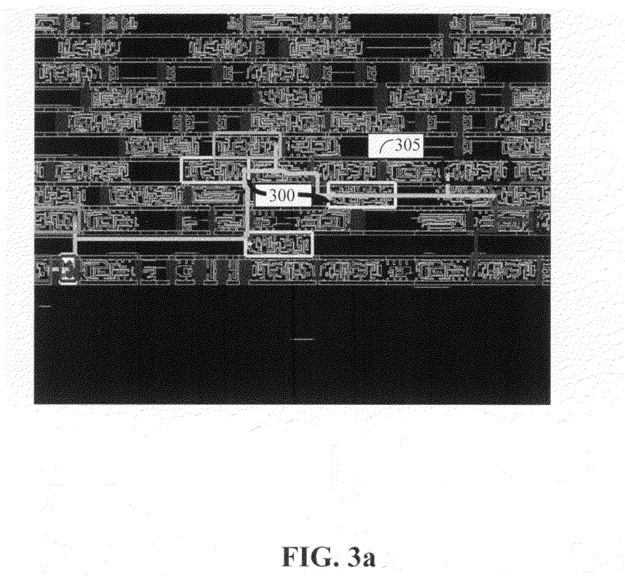

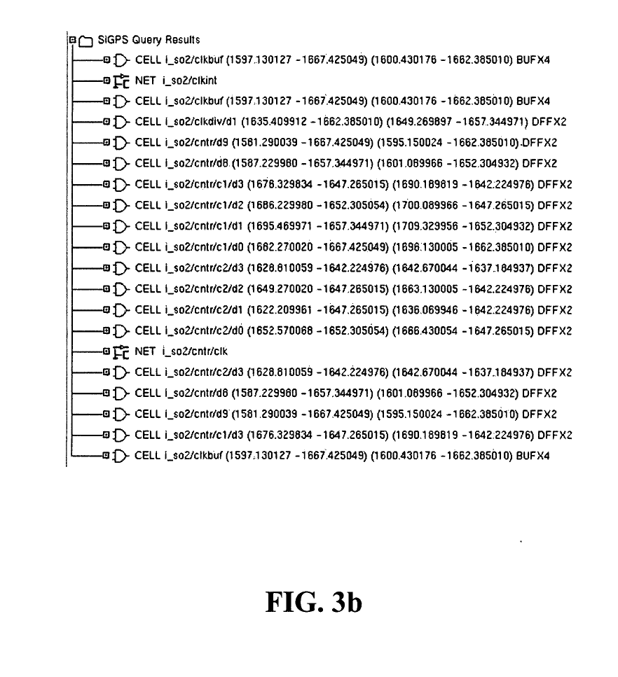

FIG. 3a shows an example of a portion of an IC, with highlighted regions 300 indicating cells connected to cell 305, where a failure is detected or a design problem correction is anticipated. FIG. 3b shows the result of an exemplary SiGPS query to identify the net and other connected cells to the originally identified cell 305. (The SiGPS is a Credence Proprietary database which is in binary format and has been created by reading LEF/DEF files. It allows the user to query by net/cell names, and returns polygons corresponding to the cell/net). In order to determine which portions of the surrounding net or other features are pertinent to the analysis of a failure e.g., in determining which cells may need to be probed in order to exactly locate the failure, the user may take assistance from ATPG tools which simulate the faults and determine potential causes and their locations. The complete net might be sent into the enhanced GDS file, or if it is too big, the appropriate portion of the net that needs to be edited can be sent into the enhanced GDS file.

Once the problematic cell and connected net and/or cells are identified, the exact location or locations for a circuit edit, if any is required, must be determined. Again, this often involves probing of multiple cells. The determination may be made subjectively, using the experience of the user or operator. The OP3 algorithms described earlier can aid in automatic identification of preferred probe points, net cuts, and net joins.

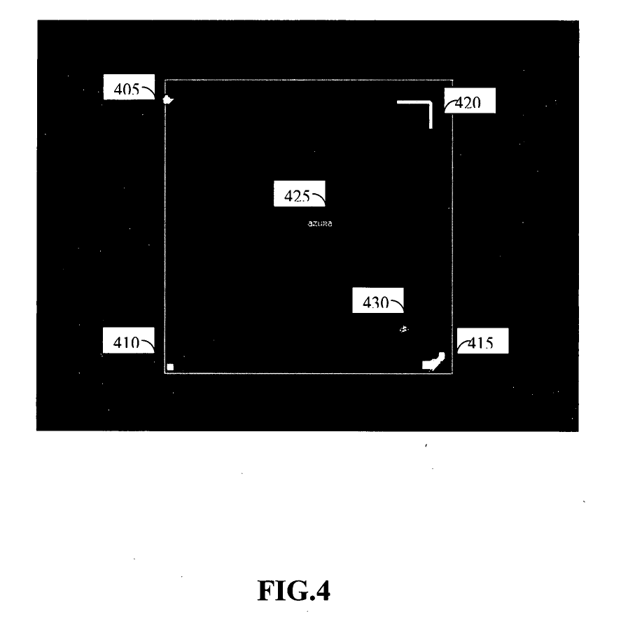

In step 120, illustrated in FIG. 4, a new GDS2 file is created which has the same bounding box 400 as the original mask data and layout files, and includes the unique features 405, 410, 415, and 420, as well as the design specific information, for example the possible locations to do a net cut or a net join, or the nearby regions of the net (regions 425, 430) which need to be probed in order to determine the exact failure location. This new GDS file will be designated hereinafter as the FA-specific GDS file. The locations may be obtained in different ways, depending on the source of the information. For example, if a desired probing or edit location is obtained from ATPG results which pinpoint the failure to a specific pin or a specific schematic element, the locations or names from the schematic are used to do query in LVS and/or LVS/DEF database. The results of the query are the corresponding polygons, which are then converted into GDS2 file format. The original layers can be used, or all the polygons can be treated as being on the same layer and then dumped into the correct GDS2 format. This new GDS2 file is transferred to the failure analysis facility. The failure analysis engineers use the equipment's layout tool or equipment driver tool to load the GDS2 file. The unique features 405,410, 415, and 420 are used to do the alignment of the silicon on the equipment relative to the GDS2 file.

The above steps are followed with slightly different emphasis for three different failure analysis scenarios. These are:
1) An observed circuit failure problem;
2) A design problem; and
3) A diagnostics failure.

1. Circuit Failure Problems

Actual failures in operating circuits are generally detected and often located by the customer. Such failures are in many cases caused by processing problems such as incomplete etch, residues, etc. The location may be well-defined and localized, as when emission microscopy identifies a failure-related emission site, or it may mean an entire net if the failure is detected electrically to be a short, for example. In this case, the appropriate need-to-know information for the failure analysis is provided in the new enhanced GDS file after the customer indicates the failure location. For example, if an emission site is identified, the nets, cell instances, and vias in and around the emission site can be highlighted and exported into the GDS2. The specific information necessary to transfer depends upon how much of the failure analysis is being done by the fab house and how much by the design house. In general, the design house specifies which cells need to be probed to exactly identify and locate the failure site, but the fab or FA house may do the actual probing of several locations, which may necessitate their having the localized connectivity and/or schematic information about those cells or locations.

2. Design Problems

Design problems are generally identified by the design house, often after operational failures are seen for some or all devices using a particular design. In general, to correct a design problem, a circuit edit is necessary at a specific location or locations. The design team generally performs the edit planning, and in that case is required to determine the precise location and type of circuit edit required. To this end, once the functional location of the required edit is determined, algorithms such as the enhanced OP3 algorithms described in U.S. patent application Ser. No. 11/502,951, incorporated above, may be used to determine the optimal location of any required net cuts, net joins, or probe points to be utilized in the edit. In this case, the enhanced GDS2 file may include such features as the actual metal numbers, as well as dummy metal (either the entire layer or the dummy metal in the vicinity of the net/cell in question). Further markers may be added to facilitate performing cuts and joins. For example, text can be added into the enhanced GDS layer at appropriate locations. I.e., text could be placed at location (10, 10) saying “cut the net here” or “start the join here”.

3. Diagnostic Failures

A diagnostic failure occurs when a chip is being subjected to testing as opposed to an operational failure. Methods such as Time Resolved Emission/Laser Voltage Probe (LVP) results from Automatic Test Pattern Generation (ATPG) tools are commonly used. The failures reported by ATPG tools are in the form of cell/pin names. These pin names can be queried, highlighted, and exported into the enhanced GDS file. For example, scan chains, i.e., the sequence of how the test is performed in order to put the chip into a certain state such as an error state, can be used in the probing. In this case, the FA house may get sufficient information from the ATPG tools to know where to probe to determine the type of failure and the failure site, e.g., by probing the pin outputs of a cell.

The present invention provides a methodology for limiting the information transferred from a design facility to a fabrication or failure analysis facility to that which is necessary to perform the requested tasks. In this way, proprietary design information can often be retained by the design facility while not compromising the effectiveness of the failure analysis job.

### System Requirements

The invention includes apparatus for carrying out the described methods and methodology. Such apparatus preferably comprises a suitably-programmed and configured general-purpose data processing or computer system, such as that of data processing system or a CAD workstation system used to perform routing and layout of an IC. Data storage medium is included which may comprise disk storage. Data processing capability and displays which may be used for operator interface with the data processing system are further described in U.S. Pat. No. 5,675,499, which is hereby incorporated by reference.

It is not expected that the invention be limited to the exact embodiments described herein. Those skilled in the art will recognize that changes and modifications can be made without departing from the inventive concept. For example, the exact formats of the transferred files may vary. In addition, improvements may be made in the algorithms used to optimize edit points. The scope of the invention should be construed in view of the claims.

With this in mind, we claim:

1. A method for an Integrated Circuit (IC) design facility to transfer design and layout information to an external facility, for failure analysis of said IC chip, comprising the steps of:
creating a Failure Analysis (FA)-specific layout file including the minimum design-specific information required to enable effective failure analysis; and
providing said FA-specific layout file to said external facility.

2. The method of claim 1, wherein said FA-specific layout file has an equivalent bounding box as original layout files for fabrication of said IC, said FA-specific layout file further including a plurality of unique features for aligning said FA-specific layout file to said original layout files.

3. The method of claim 2, wherein said IC chip has a plurality of corners, and further comprising the steps of:
a) identifying a said unique feature on said IC chip associated with each of said plurality of corners, yielding a plurality of unique features;
b) marking said plurality of unique features on a first set of layout files associated with said IC chip, said first set of layout files equivalent to said original layout files and having a bounding box;
c) marking design-specific features necessary to said failure analysis on said first set of layout files;
d) creating a second set of layout files having the same said bounding box as said first set of layout files, said second set of layout files including said plurality of unique features and said design-specific features marked on said first set of layout files; and
e) transferring said second set of layout files to said external facility.

4. (canceled)

5. (canceled)

6. The method of claim 3, wherein said first and second sets of layout files are GDS2 files.

7. The method of claim 3, wherein said design-specific features are determined by an operating circuit failure and wherein said operating circuit failure is indicated by an emission site.

8. (canceled)

9. The method of claim 8, wherein said design-specific features include at least one of: nets, cell instances, and vias in and around said emission site:

10. The method of claim 3, wherein said design-specific features are determined by a design flaw.

11. (canceled)

12. (canceled)

13. (canceled)

14. The method of claim 3, wherein said design-specific features are determined by a diagnostic failure.

15. (canceled)

16. (canceled)

17. (canceled)

18. (canceled)

19. A data processing system adapted to enable transfer of Failure Analysis-specific layout files from a design facility to an external facility, said data processing system configured to perform the steps of:
a) identifying a unique feature on an IC chip associated with each of a plurality of corners of said IC chip, yielding a plurality of unique features;
b) marking said plurality of unique features on a first set of layout files associated with said IC chip, said first set of layout files equivalent to original layout files and having a bounding box;
c) marking design-specific features necessary to failure analysis on said first set of layout files; and
d) creating a second set of layout files having the same said bounding box as said first set of layout files, said second set of layout files including said plurality of unique features and said design-specific features marked on said first set of layout files.

20. An FA-specific file configured to enable transfer of a Failure Analysis-specific layout file of an IC from a design facility to an external facility including the minimum design-specific information required to enable effective failure analysis of said IC.

21. The FA-specific file of claim 20, wherein said Failure Analysis-specific layout file is a GDS2 file.

22. The FA-specific file of claim 20, wherein said Failure Analysis-specific layout file has an equivalent bounding box as original layout files for fabrication of said IC, said Failure Analysis-specific layout file further including a plurality of unique features for aligning said Failure Analysis-specific layout file to said original layout files.

23. The FA-specific file of claim 22, wherein:
said plurality of unique features are equivalent to unique features on said IC associated with each of a plurality of corners; and
said Failure Analysis-specific layout file including the minimum set of design-specific features from said original layout files necessary to enable said effective failure analysis.

24. The FA-specific file of claim 23, wherein:
said design-specific features are determined by an operating circuit failure indicated by an emission site; and
said design-specific features include at least one of: nets, cell instances, and vias in and around said emission site.

25. The FA-specific file of claim 23, wherein said design-specific features are determined by a diagnostic failure.

26. The FA-specific file of claim 25, wherein said diagnostic failure is identified by an Automatic Test Pattern Generation (ATPG) tool.

27. The FA-specific file of claim 26, wherein said ATPG tool provides results selected from the group consisting of: Time Resolved Emission and LVP.

28. The FA-specific file of claim 27, wherein said results are queried, highlighted, and exported into said Failure Analysis-specific layout file.

29. A data storage medium containing the FA-specific file of claim 20.

30. A data storage medium containing the FA-specific file of claim 23.
